(19) United States
(12) Patent Application Publication
(10) Pub. No.: US 2003/0072642 A1
(43) Pub. Date: Apr. 17, 2003

(54) Three position pallet shuttle

(76) Inventor: Mathew Evans, Stoughton, WI (US)

Correspondence Address: David I. Roche, BAKER & McKENZIE, 130 E. Randolph Drive, Chicago, IL, 60601, US

(21) Appl. No.: 09/759,682

(22) Filed: Jan. 12, 2001

(51) Int. Cl. B65G 1/00

(52) U.S. Cl. 414/539; 414/522; 414/222.1

(57) ABSTRACT

A pallet shuttle for presenting pallets to and unloading pallets from a machining center. The pallet shuttle has tow pallet carriers capable of moving pallet to three positions. The motion of the pallet carriers is achieved by a combination of cylinders one of which couples the carriers to each other, and the other of which moves the carriers relative to the base to which the carriers are mounted. By having the capability to move pallets to three positions, the shuttle allows an operator to quickly and efficiently remove finished parts from and put raw parts into the machining center whenever the need arises. The three-position capability allows an operator to have raw parts ready and waiting.

### BACKGROUND AND SUMMARY OF THE INVENTION

This invention relates to pallet changing shuttles used with machining centers and, in particular, relates to a pallet shuttle in which pallets with raw and finished parts may be moved to pallet positions in a manner which optimizes the use and value of a machining center.

Machining centers are typically very expensive pieces of equipment, and the skilled people who operate them are, in at least some cases, are highly paid. Thus, it is desirable to operate machining centers in the most efficient way possible. Optimum usage, both from the standpoint of machining time, and operator time, is necessary in order to justify the capital expenditure involved in acquiring a machining center. One way of helping to optimize the profitability of machining centers, and thereby, justify the cost of purchase, is to increase the ratio of the number of machines to the number of operators needed to keep the machines running, whether there is one operator or a team of people preparing and unloading workpieces. Arrangements in which an array of machining centers are served by one or more workers is sometimes called a flexible machining system. Such systems may be more or less mechanized with a variety of carts and/or track systems used to bring pallets of workpieces into the area of the machining centers.

Quickly removing finished parts and placing raw parts into the machining center is a primary objective for pallet changing devices. Furthermore, it is important to provide efficient interchange of finished and raw parts without utilizing an excessive amount of floor space in a factory. The invention allows an operator of a machining center to exchange raw and finished parts in a highly efficient manner. A number of pallet handling systems are used in connection with machining centers of various types. Examples include the pallet changer disclosed in U.S. Pat. No. 5,370,212. The '212 patent shows a two position pallet changing device. Another example is shown in U.S. Pat. No. 4,890,371. The '317 patent discloses a pallet changer for a machining center which includes a table that indexes 180°. Yet another example of a pallet changing machine is shown in U.S. Pat. No. 5,810,541. The system of the '541 patent includes a moving platform, one side of which has a wheel and another side of which is mounted on a guideway.

The pallet changer of the present invention includes a base located adjacent to a machining center. The pallet changer further includes an overhead pallet mover for rolling pallets on rollers into and out of the machining center. The rollers are on upwardly facing surfaces of both the pallet changing device and the machining center, where in each case, pneumatic locking or gripping devices hold the pallets in positions where they are held and parts mounted to the pallets are machined. If a cart is used to move loaded pallets to and from the pallet shuttle, the carts will be equipped with upwardly facing rollers in a manner similar to the pallet carriers and machining center.

The three position pallet shuttle of the present invention has first, second and third pallet positions, the second pallet position being co-axial with the location of the workstation in the machining center where machining takes place. The first and third pallet positions of the three position pallet shuttle of the present invention provide temporary holding positions for pallets with raw parts as those pallet await insertion into the machining center. The first and third pallet positions are also used to hold pallets with finished parts as those pallets are awaiting removal from the pallet shuttle.

The three position pallet shuttle of the present invention has beneficial application in a variety of factory floor arrangements. In a simple machining operation without any flexible machining capability, the three position pallet shuttle of the present invention provides for economy of floor space because raw parts and machine parts can be loaded onto the pallets from one side of the pallet shuttle while the pallet is in the pallet shuttle. The three position pallet shuttle of the present invention also has application in the context of a manual flexible machining center in which a cart is, for example, pushed by hand and used to bring raw parts to the shuttle and the same cart is used to remove machined parts from the shuttle. Finally, the three position pallet shuttle of the present invention has beneficial application in the context of a full flexible machining operation in which, for example, rows of machining centers are served by a pallet delivery system in which a two-pallet cart moves along a guideway between the two rows of machining centers. Each machining center in this full flexible machining system has a three position pallet shuttle of the present invention, allowing for optimum delivery of raw parts and removal of machined parts from each machining center.

The three position pallet shuttle of the present invention includes two pallet carriers mounted to the base of the pallet shuttle. The first pallet carrier is mounted to a set of outer rails, while the second pallet carrier is mounted to an inner set of rails. The relative position of the pallet carriers is adjusted by the use of a first cylinder (preferably pneumatic). The rod (the distal end thereof) of the first cylinder is mounted to the first pallet carrier, and the housing of the cylinder is mounted to the second pallet carrier. The positions of the pallet carriers relative to the base are adjusted by the use of a second cylinder (again, preferably pneumatic). The housing of the second cylinder is mounted to the base of the shuttle and the rod (distal end) is mounted to the second pallet carrier. The combination of cylinders is such that the first pallet carrier is capable of being moved to any of three pallet positions in the three position pallet shuttle, and the second pallet carrier is able to be moved between two of the three pallet positions in the shuttle.

### BRIEF DESCRIPTION OF THE DRAWINGS

The advantages and benefits of the present invention will become apparent from the following description of one example of the present invention when read in connection with the accompanying drawings, wherein:

FIG. 1 is a plan view of a three position pallet shuttle of the present invention used in the context of a simple machining operation, i.e., one in which no flexible machining system is used;

FIG. 2 is a plan view of a series of machining centers and associated three position pallet shuttles of the present invention in an environment in which several machining centers in an array are serviced by an operator with a push cart, i.e., a simple flexible machining system;

FIG. 3 is a plan view of a series of machining centers and associated three position pallet shuttles of the present invention in an environment with full flexible machining system capability;

FIG. 4 is a plan view of a three position pallet shuttle made in accordance with the present invention with the pallets now shown;

FIG. 5 is a plan view of a three position pallet shuttle and an associated machining center in which a rush order is being inserted into the machining center;

FIGS. 6 and 7 show steps in the use of a three position pallet shuttle in accordance with the present invention in a simple machining operation;

FIG. 8 and 9 show steps in which parts are being inserted into and removed from a three position pallet shuttle of the present invention in the context of a simple flexible machining operation;

FIGS. 10 and 11 show steps in the delivery of raw parts and removal of finished parts from a three position pallet shuttle of the present invention in the context of a full flexible machining system.

FIG. 12 is a side elevational view of the pallet shuttle of the present invention.

### DETAILED DESCRIPTION OF AN EMBODIMENT OF THE PRESENT INVENTION

FIGS. 1, 6 and 7 show a simple machining arrangement in which parts are loaded and unloaded by an operator 11 directly into and out of pallet shuttle 10. The operator reaches into and works on a pallet held in the first pallet position 14 of a three position pallet shuttle 10. The three position pallet shuttle 10 is mounted directly adjacent to a machining center 12. The three position pallet shuttle 10 has a first pallet position 14, a second pallet position 16, and a third pallet position 18. Movement of the pallet carriers within the three position pallet shuttle 10 (explained more fully below) allows the operator 11 to work entirely from one side of the three position pallet shuttle 10. The simple machining arrangement 2 shown in FIG. 1 allows maximum use of floor space within a factory, and the operator 11 is not required to load parts directly to the third pallet position 18 as might have been required in prior art pallet shuttle systems.

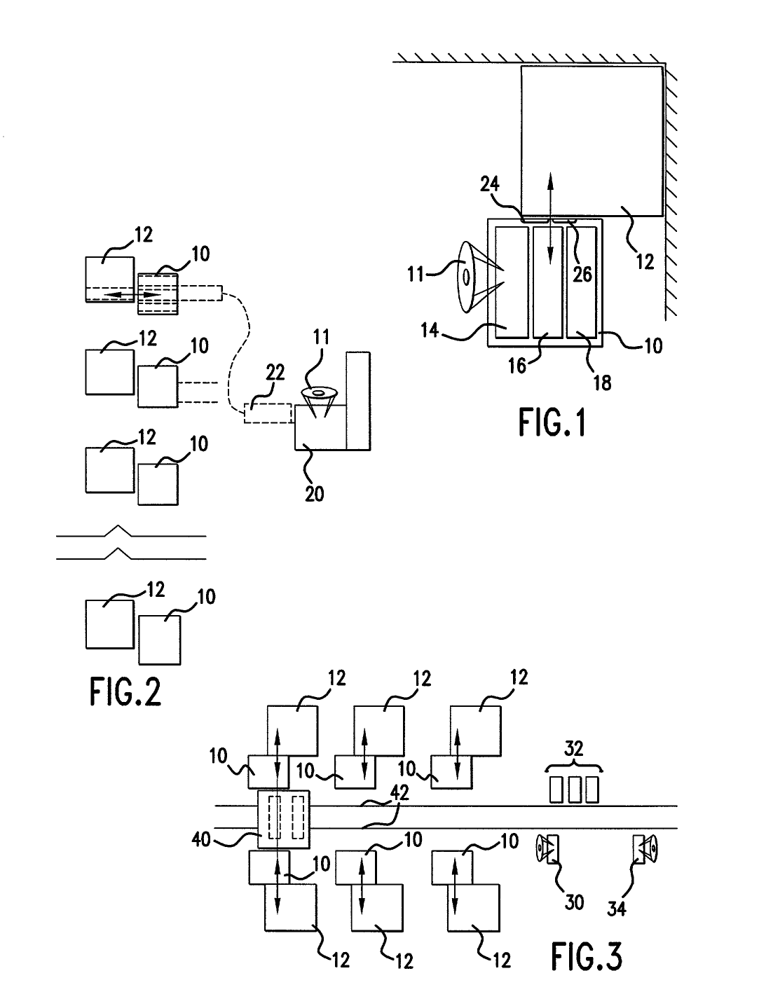

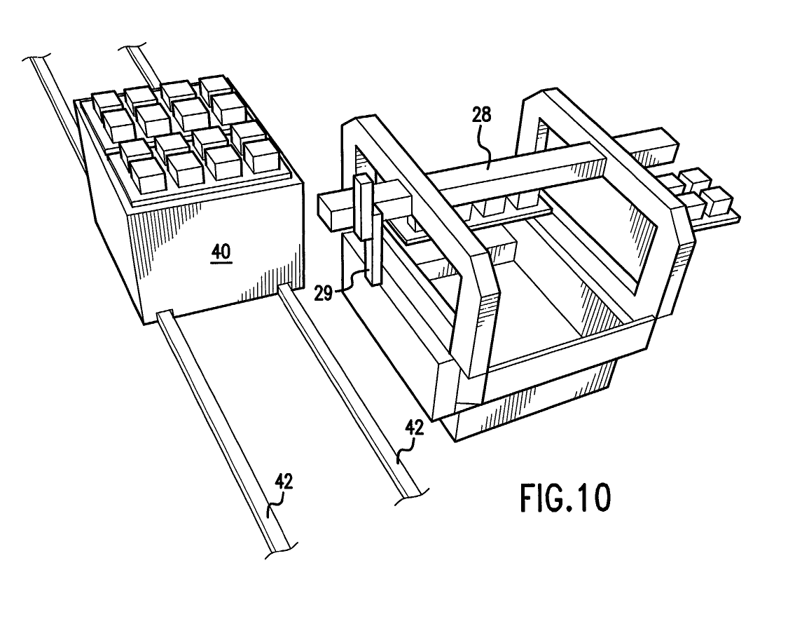

FIGS. 2, 8 and 9 show a manual flexible machining system in which an operator 11 (or a team of operators), working from a preparation station 20, services and is responsible for several machining centers. The operator 11 loads and unloads parts from a push cart or vehicle 22. The operator 11, on an as needed basis, delivers parts to and unloads parts from each of the several three position pallet shuttles 10 for which he or she is responsible. In each instance, a machining center 12 has an associated three position pallet shuttle 10. As will be explained more fully below, the cart 22 is aligned with the middle or center pallet position in each three position pallet shuttle 10. When the cart 22 is aligned with the second pallet position of a three position pallet shuttle 10, raw parts may be inserted into the shuttle and finished parts may be unloaded onto the cart 22, both movements being carried out adjacent to the middle or second pallet position with the assistance of the overhead pallet mover 28 with a downwardly depending arm 29 See, e.g., FIGS. 10, 11 and 12.

FIGS. 3, 10 and 11 show a full flexible machining system in which the machining centers 12 are equipped with the three position pallet shuttle 10 of the present invention. A multi-pallet carrier 40 with at least two pallet positions serves machining centers with associated three position pallet shuttles on either side of set of tracks 42 on which the multi-pallet carrier 40 is mounted. The carrier 40 delivers parts from a preparation station 30 and/or an auxiliary preparation station 32 in which an operator prepares pallets with raw parts for delivery to the three position pallet shuttles 10 and to the respective machining centers 12. When parts are finished, the three position pallet shuttles 10 are used to extract the finished parts from the machining center and the three position pallet shuttles 10 immediately delivers raw parts back into the machining centers 22. The finished parts await the arrival of the multi-pallet carrier 40 which carries the finished parts to a checking station 34.

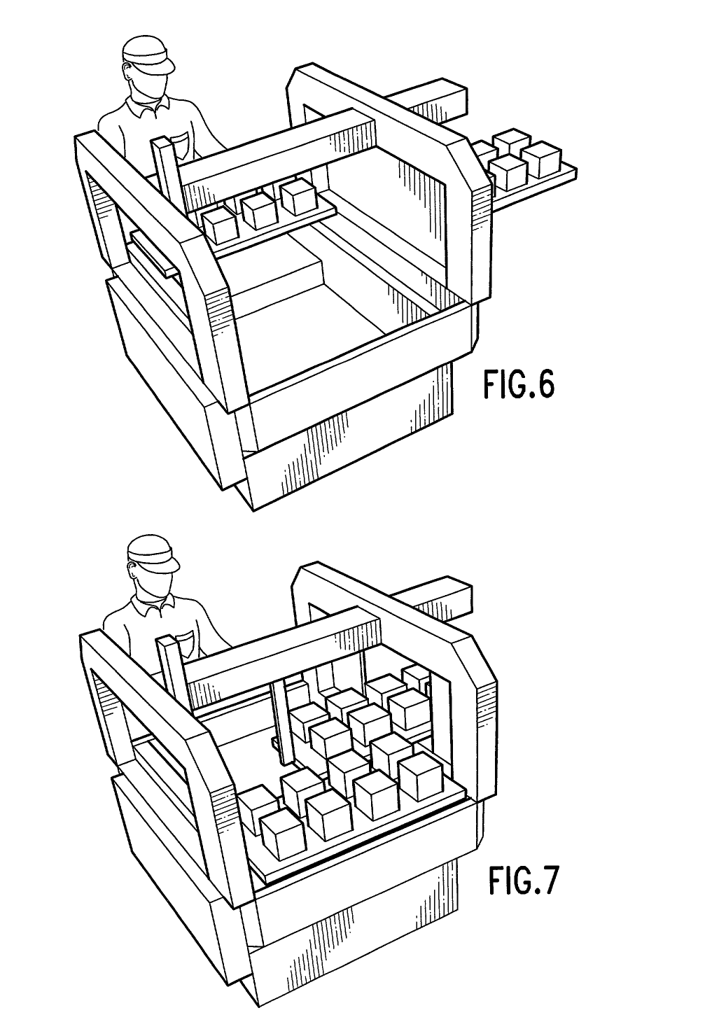

The sequence of delivery and movement of raw and finished parts in each of the foregoing alternative environments will be explained more fully below, and will be better understood by reference to FIGS. 6 through 11 below.

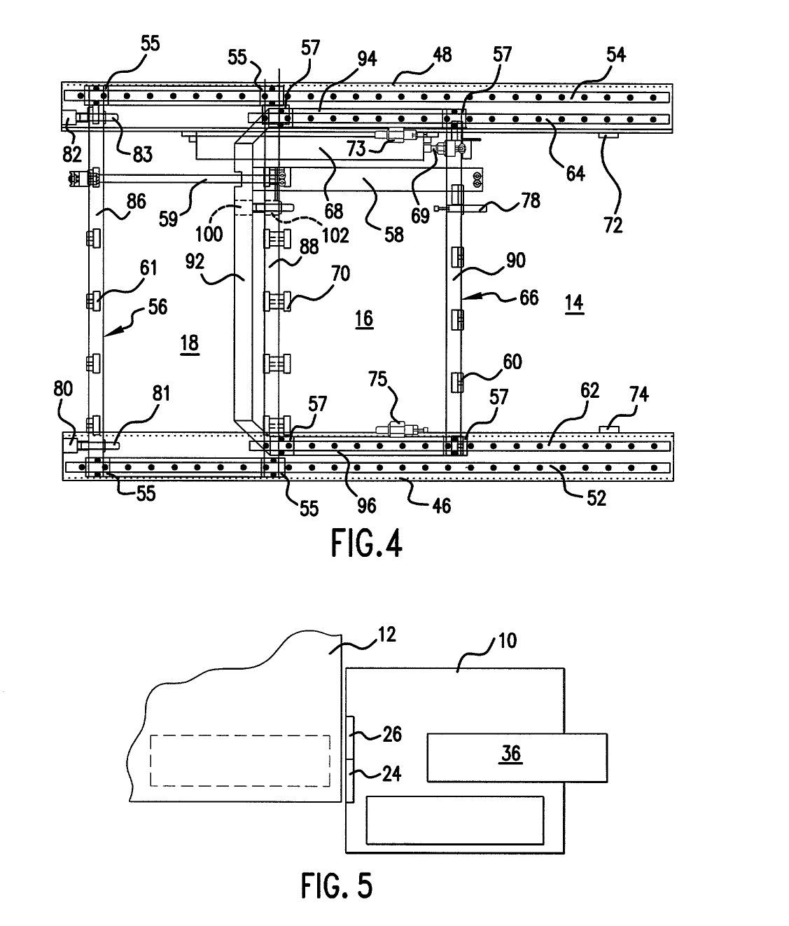

FIG. 4 is a plan view showing an arrangement of pallet carriers 56 and 66 mounted to a pallet shuttle base 44 comprised of a first main support 46 and a second main support 48. The first pallet carrier 56 rides along a pair of outer rails 52 and 54. The first outer rail 52 is mounted to the first main support 46, and the second outer rail 54 is mounted to the second main support 48. Runner blocks 55 guide the movement of the first pallet carrier 56 along the rails 52 and 54. Similarly, the second pallet carrier 66 is mounted to an inner pair of rails 62 and 64. The first inner rail 52 is mounted to the first main support 46, and the second inner rail 64 is mounted to the second main support 48. Runner blocks 57 guide the movement of the second pallet carrier 66 along the pair of inner rails 64 and 66.

The movement of the pallet carriers 56 and 66 from position to position is controlled by the operation of two cylinders 58 and 68. The first cylinder 58, preferably a pneumatic cylinder, includes a rod 59 which extends from and retracts into the cylinder 58. The distal end of the rod 59 is connected to the first long strut 86 of the first pallet carrier 56. The body of the cylinder 58 is connected to the first and second long struts 90 and 92 of the second pallet carrier 66. As the rod 59 is drawn into the cylinder 58, the first pallet carrier 56 is brought into a position in which it overlies the second pallet carrier 66. A second cylinder 68 includes a rod 69. The second cylinder 68 is mounted to the second main support 48, and the distal end of the rod 69 is mounted to the first long strut 90 of the second pallet carrier 66. As the rod 69 extends from the second cylinder 68, the second pallet carrier moves from the second (middle) pallet position 16 to the first pallet position 14. Extension of the rod 69 from the second cylinder 68 can occur with the rod 59 either extending (as shown) from the first cylinder 58 (in which the first pallet carrier is in the third pallet position 18), or with the rod 59 retracted into the first cylinder 58.

Thus, for example, the first pallet carrier 56 can be moved from the third pallet position 18 to the first pallet position 14 by a sequence of operations of the first and second cylinders 58 and 68. From the position shown in FIG. 4, retraction of the rod 59 into the cylinder 58 moves the first pallet carrier 56 from the third pallet position 18 to the second pallet position 16. Then, extension of the rod 69 from the second cylinder 68 will cause the first pallet carrier 14 to then move from the second pallet position 16 to the first pallet position 14.

A series of switches and stop blocks assist the cylinders in controlling the motion of the first and second pallet carriers from the various pallet positions of which they are capable of assuming. In particular, the switch 73, which is mounted to the short strut 94 of the second pallet carrier 66 encounters a stop block 72 when the second pallet carrier is in the first pallet position 14. Similarly, the switch 75 engages stop block 74 when the second pallet carrier 66 is in the first pallet position 14. The switch 77 which is carried by the second long strut 88 of the first pallet carrier 56 engages a stop block 100 carried by the second long strut 92 of the second pallet carrier 66 when the first and second pallet carriers 56 and 66 are in the laterally adjacent position shown in FIG. 4. Similarly, the switch 78 carried by the first long strut 90 of the second pallet carrier 66 engages a stop block 102 mounted on the underside of the second long strut 88 of the first pallet carrier 56 when the first and second pallet carriers 56 and 66 are occupying the same pallet position, i.e., either the second pallet position 16 or the first pallet position 14.

The second long strut 88 of the first pallet carrier 56 contains a series of tandem rollers 70. The right hand rollers (as shown in FIG. 4) of the series of tandem rollers 70 cooperate with the series of single rollers 60 which are mounted on the first long strut 90 of the second pallet carrier 66. Similarly, the left hand rollers (as shown in FIG. 4) of the series of tandem rollers 70 cooperate with the single rollers 61 which are mounted on the first long strut 86 of the first pallet carrier 56.

FIG. 5 is a plan view showing a pallet with a rush order 36 being inserted into the pallet shuttle 10. The three-position pallet shuttle of the present invention makes it very easy for an operator to interrupt a scheduled machining operation, and to insert a pallet 36 which must be done out of sequence on a rush basis.

FIGS. 6 and 7 show a simple machining operation corresponding to the layout shown in FIG. 1. The operator 11 in FIGS. 6 and 7 is able to service the pallet shuttle and associated machining center 12 from only one side of the three position pallet shuttle 10 (the far side, as shown in FIGS. 6 and 7). In FIG. 6, the operator 11 is shown replacing finished parts with raw parts while the loaded pallet on which he is working is in the first pallet position 14. Meanwhile, the machining center (not shown in FIG. 6) is converting raw parts to finished parts. When the operator has completed removing finished parts and loaded the pallet he is working on with raw parts, the first pallet carrier 56, which is holding the pallet which he has loaded as shown in FIG. 6, has moved to the third pallet position 18, as far as possible from his position as shown in FIG. 6. Moving the raw parts from the first pallet position 14 to the third pallet position 18 is done at the time when the machining center 22 is finished converting the raw parts to finished parts. At that point, the sliding doors 24 and 26, which are at the interface between the three position pallet shuttle 10 and the machining center 12, are opened and the finished parts are moved into the second pallet position 16. Then, the raw parts at the third pallet position 18 are moved to the second pallet position 16 and the finished parts are moved from the second pallet position 16 to the first pallet position 14, where the operator 11 then manually replaces finished parts with raw parts.

While the operator 11 is working on the pallet located in the first pallet position 14, the raw parts are moved from the second pallet position 16 into the machining center for conversion to finished parts by the machining center 12. Again, just prior to completion of the conversion of raw parts to finished parts by the machining center 12, the newly loaded raw parts in first pallet position 14 are moved to the third pallet position 18, and the parts in the machining center 12 are moved from the machining center 12 to the second pallet position 16. Then, in tandem, the two loaded pallets in the three position pallet shuttle 10 are moved in the direction of the operator 11 so that the finished parts are presented to the operator and the new raw parts are moved into the second pallet position 16 for insertion into the machining center 12. This entire cycle may be repeated over and over while the operator 11 is standing in the position shown in FIGS. 6 and 7. Therefore, the machining center 12 and shuttle 10 could be located in a corner of a factory floor. A wall 28, as shown in FIG. 1, may limit access to the third pallet position 18 without adversely affecting the ability of the operator to provide raw parts to the machining center of FIG. 1.

The following is a summary of the sequence of movement in a simple (non-flexible machining system) with the designation “PP” meaning pallet position:

No Flexible Machining—One-sided access

1. Start of Cycle: Raw Parts (Set 2) at PP 1 Finished parts (Set 1) at PP 2 Machine empty

2. Raw parts (Set 2) at PP 1>Raw parts (Set 2) at PP 2 Finished parts (Set 1) at PP 2>Finished parts (Set 1) at PP 3

3. Raw parts (Set 2) from PP 2 into Machine

4. Finished parts (Set 1) at PP 3>Finished parts (Set 1) at PP 1

Note: Raw in machine (Set 2) are converted to finished parts, while finished parts (Set 1) at PP 1 are replaced with new Raw parts (Set 3) at PP 1.

5. Raw parts (Set 3) at PP 1>Raw parts (Set 3) at PP 3

6. Finished parts in Machine (Set 2) are moved to PP 2

7. Finished parts (Set 2) at PP 2>Finished parts (Set 2) at PP 1 Raw parts (Set 3) at PP 3>Raw parts (Set 3) at PP 2

8. Raw parts (Set 3) at PP 2 are moved into Machine

9. Raw parts in machine (Set 3) are converted into finished parts, while finished parts (Set 2) at PP 1 are replaced with new raw parts (Set 4) at PP 1.

10. Finished parts (Set 3) in Machine are moved into PP 2

11. Raw parts (Set 4) at PP 1>Raw parts (Set 4) at PP 2 Finished parts (Set 3) at PP 2>Finished parts (Set 3) at PP 3

12. Raw parts (Set 4) are moved from PP 2 into Machine

13. Finished parts (Set 3) at PP 3 are moved to PP 1

14. Raw parts in machine (Set 4) are converted into finished parts, while finished parts (Set 3) at PP 1 are replaced with new Raw parts (Set 5).

15. Raw parts (Set 5) at PP 1>Raw parts (Set 5) at PP 3

17. Finished parts from Machine (Set 4) are moved to PP 2

18. Finished parts (Set 4) at PP 2>Finished parts (Set 4) at PP 1 Raw parts (Set 5) at PP 3>Raw parts (Set 5) at PP 2

19. Raw parts (Set 5) at PP 2 are moved into Machine

20. Raw parts in machine (Set 5) are converted into finished parts, while finished parts (Set 4) at PP 1 are replaced with new raw parts (Set 6) at PP 1.

21. Finished parts from Machine are moved to PP 2

Repeat: go to Step 9

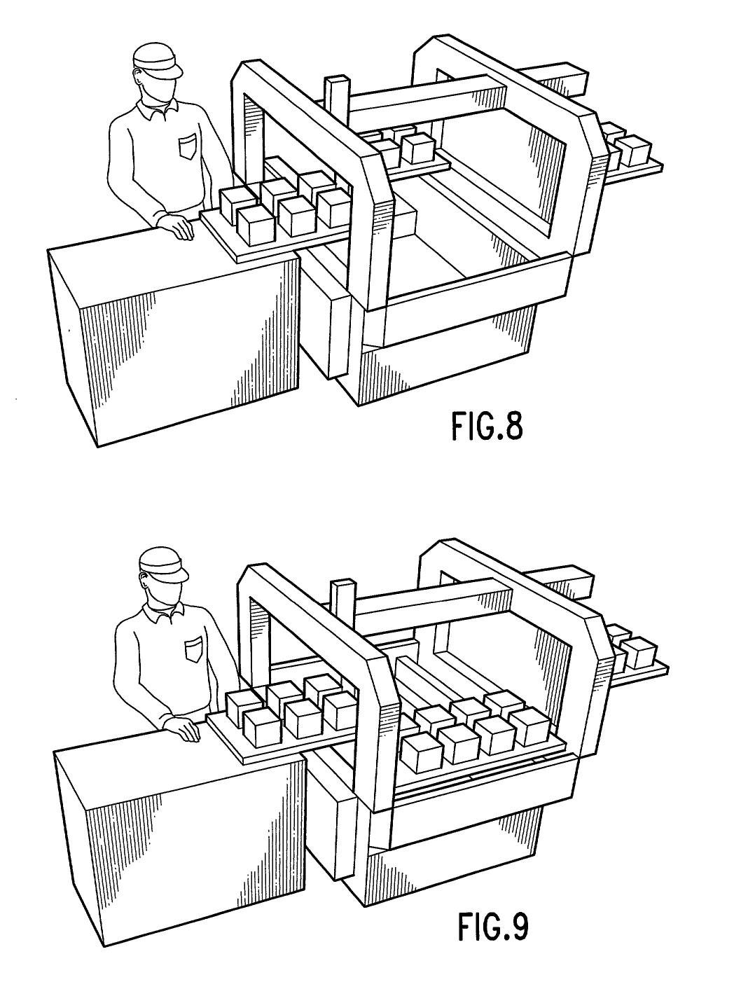

FIGS. 8 and 9 are examples of various positions in which a three position pallet shuttle 10 of the present invention is used in connection with a manual or partially flexible machining system, a exemplary layout of which is shown in FIG. 2. An operator 11 utilizes a moveable cart 22 capable of carrying a single pallet of either raw or finished parts. The cycle of a system in which a manual flexible machining system is in operation will be described. At the start of a cycle it is assumed that raw parts are in the first pallet position 14 and finished parts are at the second pallet position 16. The next step is for the pallets to be moved laterally, the raw parts moving from the first pallet position 14 to the second pallet position 16, and the finished parts moving from the second pallet position 16 to the third pallet position 18. From this point, the raw parts can be moved from the second pallet position 16 into the machining center 12. Then, the finished parts are moved from the third pallet position 18 to the first pallet position 14, and an empty second pallet carrier 66 is moved to the second pallet position 16 onto the second pallet carrier 66. The operator then moves a cart 22 with raw parts into position adjacent to the second pallet position 16 and raw parts are moved into the second pallet position 16. Then, the raw parts are moved from the second pallet position 16 to the third pallet position 18, while the previously finished parts are moved from the first pallet position 14 to the second pallet position 16. The cart 22 is then loaded with the finished parts from the second pallet position 16 (i.e. from the first pallet carrier 56). While the raw parts just loaded into the three position pallet shuttle 10 are in the third pallet position 18, the empty carrier in the second pallet position 16 is ready to receive the finished parts from the machining center 12. Once the finished parts are unloaded from the machining center into the second pallet position 16, the three position pallet shuttle moves the two pallets which are in the shuttle 10 from the third and second positions to the second and first position, respectively. That is, the raw parts are moved from the third pallet position 18 into the second pallet position 16, and the finished parts are moved the second pallet position 16 into the first pallet position 14.

Immediately thereafter, the raw parts can be loaded into the machining center 12 for conversion to finished parts, and the previously finished parts are held in the first pallet position 14. While the previously finished parts are in the first pallet position 14, the operator 11 brings newly loaded raw parts and slides those parts from the cart 22 into the second pallet position 16. While the machining center 12 is operating on a set of parts in the machining center 12, the three position pallet shuttle moves the finished parts which are in the first pallet position 14 to the second pallet position 16, and the newly loaded raw parts are moved from the second pallet position 16 to the third pallet position 18. This allows the operator 11 to withdraw the previously finished raw parts from the second pallet position 16. While the newly loaded raw parts are held in the third pallet position 18, the finished parts are unloaded from the machining center to the second pallet position 16, thus completing the cycle.

The following is a summary of the sequence of movement in a manual flexible machining system, again with the designation “PP” meaning pallet position:

Manual Flexible Machining

1. Start of Cycle: Raw Parts (Set 2) are at PP 1 Finished parts (Set 1) at PP 2 Machine Empty

2. Raw parts (Set 2) at PP 1>Raw parts (Set 2) at PP 2 Finished parts (Set 1) at PP 2>Finished parts (Set 1) at PP 3

3. Raw parts (Set 2) at PP 2>Into Machine (Set 2)

4. Finished parts (Set 1) at PP 3>Finished parts (Set 1) at PP 1

5. Raw parts (Set 2) in machine are finished, while new raw parts (Set 3) are loaded directly into PP 2 from a cart.

6. Finished parts (Set 1) at PP 1>Finished parts (Set 1) at PP 2 Raw parts (Set 3) at PP 2>Raw parts (Set 3) at PP 3

7. Finished parts (Set 1) at PP 2 are loaded onto cart, while Raw parts (Set 3) are held at PP 3. Set 1 is now completed and removed from the area of the machining center. Note: Cart has remained in position from the time new parts were delivered (Step 5) until finished parts are put on the cart—this Step 7, and the cart has only had to wait for one stroke of the pallet shuttle.

8. Finished parts from Machine (Set 2) are moved to PP 2

9. Finished parts (Set 2) at PP 2>Finished parts (Set 2) at PP 1 Raw parts (Set 3) at PP 3>Raw parts (Set 3) at PP 2

10. Raw parts (Set 3) from PP 2 are moved into Machine

11. New Raw parts (Set 4) are loaded directly into PP 2, while finished parts (Set 2) are held at PP 1.

12. Finished parts (Set 2) at PP 1>Finished parts (Set 2) at PP 2 Raw parts (Set 4) at PP 2>Raw parts (Set 4) at PP 3

13. Finished parts (Set 2) are loaded onto cart from PP 2, while Raw parts (Set 4) are held at PP 3. Set 2 is now completed, and removed from the are of the machining center. Note: Cart has remained in position from the time new parts were delivered (Step 11) until finished parts are put on the cart—this Step 13, and the cart has only had to wait for one stroke of the pallet shuttle.

Repeat: go to Step 8.

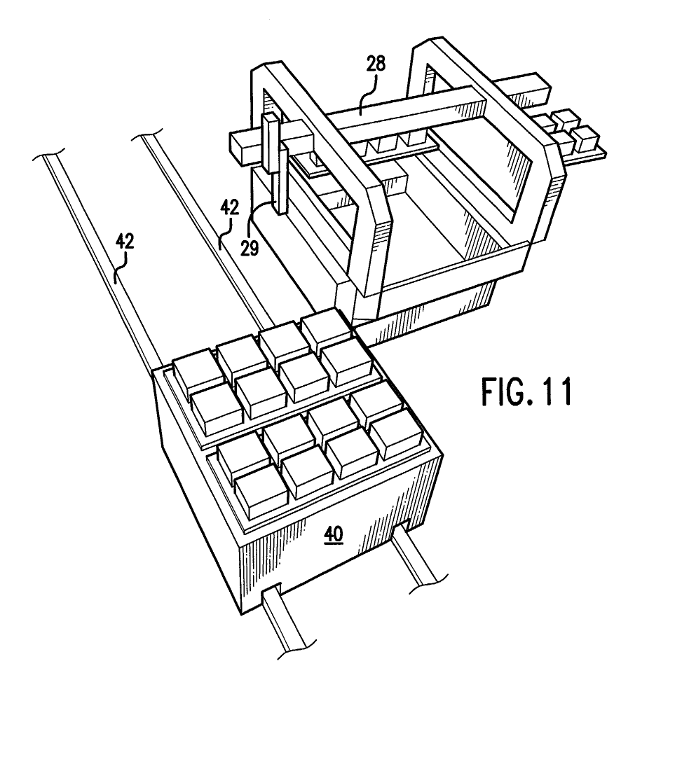

FIGS. 10 and 11 depict a full flexible machining system in which two rows of machining centers 12 are divided by a pair of tracks 42 on which rides a multi-pallet carrier 40. The multi-pallet carrier 40 is able to serve a number of three position pallet shuttles 10 (see FIG. 3) by loading and unloading to and from each side of the multi-pallet vehicle 40 from each of at least two pallet holding positions atop the multi-pallet carrier 40. In a manner similar to the manual flexible machining system described above, raw parts are presented to the second pallet position 16 of various three position pallet shuttles 10, and raw parts are placed into the three position pallet shuttle 10 at the second pallet position 16 into which the raw parts are being loaded. Similarly, when finished parts are ready to be unloaded onto the multi-pallet carrier 40, they are moved to the second pallet position 16, and one of the two pallet positions on the multi-pallet carrier 40 is aligned axially with the second pallet position 16 of a three position pallet shuttle 10 for unloading of finished parts.

In operation, a three position pallet shuttle 10 and associated machining center (not shown in FIGS. 10 and 1), are serviced by a multi-pallet carrier 40, as follows:

Full Flexible Machining

Start of Cycle: Raw parts (Set 2) at PP 1 Parts in Machine being finished (Set 1)

1. Raw parts (Set 2) at PP 1 are moved to PP 3

2. Finished parts from Machine (Set 1) moved to PP 2

3. Finished parts (Set 1) at PP 2>Finished parts (Set 1) at PP 1 Raw parts (Set 2) at PP 3>Raw parts (Set 2) at PP 2

4. Raw parts (Set 2) from PP 2 are move into machine for finishing.

5. New raw parts (Set 3) are moved from upstream location on track-cart and loaded into PP 2, while finished parts (Set 1) are held at PP 1, and while parts in machine (Set 2) are being finished.

5. Raw parts (Set 3) at PP 2>Raw parts (Set 2) at PP 3 Finished at parts (Set 1) at PP 1>Finished parts (Set 1) at PP 2

6. Finished parts (Set 1) are unloaded from PP 2 onto track-cart and are moved to checking station.

7. Finished parts (Set 2) are moved from machine to PP 2, while Raw parts (Set 3) are held at PP 3.

8. Finished parts (Set 2) at PP 2>Finished parts (Set 2) at PP 1 Raw parts (Set 3) at PP 3>Raw parts (Set 3) at PP 2

9. Raw parts (Set 3) from PP 2 are moved into machine for machining.

10. New raw parts (Set 4) are moved from upstream location on track-cart and loaded into PP 2, while finished parts (Set 2) are held at PP 1, and while parts in machine (Set 3) are being finished.

11. Raw parts (Set 4) at PP 2>Raw parts (Set 4) at PP 3 Finished parts (Set 2) at PP 1>Finished parts (Set 2) at PP 2

12. Finished parts (Set 2) are unloaded from PP 2 onto track cart and are moved to checking station

13. Finished parts (Set 3) are moved from machine to PP 2, while Raw parts (Set 4) are held at PP 3

14. Finished parts (Set 3) at PP 2>Finished parts (Set 3) at PP 1 Raw parts (Set 4) at PP 3>Raw parts (Set 4) at PP 2

Repeat: go to Step 4.

FIG. 11 shows the finished parts being carried by the multi-pallet carrier 40, along with a second set of raw parts to a downstream shuttle. The multi-pallet carrier 40 will be positioned at a second three position shuttle such that the second set of raw parts on the carrier 40 is aligned with the second pallet position 16 of a three position pallet shuttle (not shown).

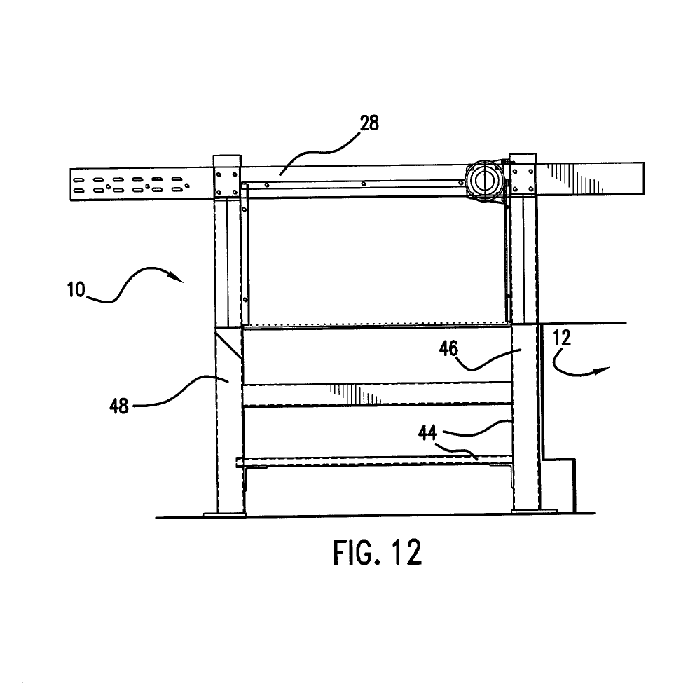

FIG. 12 shows some the framework which comprises the pallet shuttle 10. The base 44 includes a first main support 46, adjacent to the machining center 12, and a second main support 48. The overhead pallet mover 28 includes a downwardly depending arm 29 (not shown in FIG. 12, but shown in FIGS. 10 and 11). The pallet mover 28 extends beyond the main support 46 in the direction of the machining center 12 on one side, so that pallets with raw parts may be pushed into the machining center 12 from the center pallet position 16, and machined parts may be pulled from the machining center into the center pallet position 16. Similarly, the pallet mover 28 extends beyond the main support 48 into an area accessed by a cart on the other side of the pallet shuttle, so that pallets with machined parts may be pulled onto a cart from the middle pallet position 16, and raw parts may be pushed into the center pallet position 16.

The foregoing descriptions of specific embodiments of the present invention have been presented for purposes of illustration and description. They are exemplary and are not intended to be exhaustive or to limit the invention to the precise forms disclosed, and obviously many modifications and variations are possible in light of the above explanations of the specific embodiments. The embodiments were chosen and described in order to best explain the principles of the invention and some of its practical applications, to thereby enable others skilled in the art to best utilize the invention and various embodiments with various modifications as are suited to the particular future uses contemplated by them. It is intended that the scope of the invention be defined by the claims appended hereto and equivalents thereof.

What is claimed is:

1. A shuttle for presenting pallets to a machining center comprising:
a base,
a carriage assembly mounted to said base, said carriage assembly having a first pallet position, a second pallet position and a third pallet position,
said carriage assembly comprising first and second pallet carriers,
said first pallet carrier movable in a first direction between a first carrier location beneath said first pallet position and a middle carrier location beneath said second pallet position,
said second pallet carrier movable in said first direction to said first and middle carrier locations and to a third carrier location beneath said third pallet position,
each of said first and second carriers being capable of delivering a pallet to and receiving a pallet from an adjacent machining center.

2. A shuttle in accordance with claim 1 wherein said carriage assembly comprises a first pair of tracks extending in a direction generally perpendicular to said first direction, said first pallet carrier being mounted to said first pair of tracks, and said carriage assembly comprises a second pair of tracks extending in a direction generally perpendicular to said first direction, said second pallet carrier being mounted to said second pair of tracks, said second pair of tracks being spaced apart farther than said first pair of tracks.

3. A shuttle in accordance with claim 3 wherein at least said second pair of tracks extends to said first, second and third pallet positions such that said second pallet carrier is movable along said second pair of tracks to said first, second and third pallet positions.

4. A shuttle in accordance with claim 1 wherein said shuttle has a first passageway adjacent to said second pallet position and facing said machining center, said passageway having a controllable door, said door being openable and closeable whereby a pallet may be delivered to said machining center when said door is open.

5. A shuttle in accordance with claim 1 wherein said shuttle has an overhead shuttle mover with a downwardly extending arm, said arm having a lower end attachable to a pallet, said arm being movable from one side of said shuttle to another above said second pallet position.

6. A system for delivering pallets to a plurality machining centers comprising, a plurality of substantially similar pallets, a pallet preparation station, at least one mobile pallet delivery vehicle and a plurality of shuttles, each one of said plurality of machining centers having an associated shuttle, each of said associated shuttles having three pallet positions, and at least one of said associated shuttles being a three position shuttle comprising:
a base,
a carriage assembly mounted to said base, said carriage assembly having a first pallet position, a second pallet position and a third pallet position,
said carriage assembly comprising first and second pallet carriers,
said first pallet carrier movable in a first direction between a first carrier location beneath said first pallet position and a middle carrier location beneath said second pallet position,
said second pallet carrier movable in said first direction to said first and middle carrier locations and to a third carrier location beneath said third pallet position,
each of said first and second carriers being capable of delivering a pallet to and receiving a pallet from an adjacent machining center,
said shuttle having a first passageway and a second passageway, said first passageway located at one end of said second pallet position and facing a machining center, said second passageway at an opposite end of said second pallet position.

7. A system in accordance with claim 6 wherein said at least one mobile pallet delivery vehicle is a freely movable cart selectively positionable adjacent to said second passageway of said three position shuttle, and said at least one mobile pallet delivery vehicle being movable by an operator between said pallet preparation station and said second passageway of said three position shuttle.

8. A system in accordance with claim 6 wherein said at least one mobile pallet delivery vehicle is a track-mounted vehicle capable of carrying at least one pallet from said preparation station to said second passageway of said three position shuttle and to a checking station, said preparation and checking stations being adjacent to a track along which said track-mounted vehicle moves.

9. A shuttle for presenting pallets to a machining center comprising:
a base,
a carriage assembly mounted to said base, said carriage assembly having a first pallet position, a second pallet position and a third pallet position,
said carriage assembly comprising first and second pallet carriers,
said first pallet carrier movable in a first direction between a first carrier location beneath said first pallet position and a middle carrier location beneath said second pallet position,
said second pallet carrier movable in said first direction to said first and middle carrier locations and to a third carrier location beneath said third pallet position,
each of said first and second carriers being capable of delivering a pallet to and receiving a pallet from an adjacent machining center,
one of said carrier movers being coupled between said base and one of said first and second pallet carriers, and another of said carrier movers being coupled between said first and second pallet carriers.

10. A shuttle in accordance with claim 9 wherein said first and second pallet movers comprise a pair of extendible and retractable actuators.

11. A shuttle in accordance with claim 10 wherein said first actuator is a pneumatic cylinder comprised of a first cylinder housing and a first extendible and retractable arm moveable into and out of said housing, a distal end of said first arm of said first actuator being attached to said first pallet carrier, and said housing of said first actuator being attached to said second pallet carrier, and wherein said second actuator is a pneumatic cylinder comprised of a second cylinder housing and a second extendible and retractable arm moveable into and out of said housing, a distal end of said second arm of said second actuator being attached to said second pallet carrier, and said second housing being attached to said base.
